(19) United States
(12) Patent Application Publication
(10) Pub. No.: US 2021/0142085 A1
(43) Pub. Date: May 13, 2021

(54) Image processing method and related image processing system

(71) Applicant: NOVATEK Microelectronics Corp., Hsin-Chu (TW)

(72) Inventor: Min Huang, Taoyuan City (TW)

(21) Appl. No.: 16/676,446

(22) Filed: Nov. 7, 2019

(51) Int. Cl. G06K 9/03; G06K 9/00; G06K 9/40; G06K 9/20; G06T 5/00

(52) U.S. Cl. CPC G06K 9/036; G06K 9/0004; G06K 9/00087; G06T 5/001; G06K 9/40; G06K 9/2027; G06K 9/00067

(57) ABSTRACT

An image processing method includes the steps of: receiving a plurality of original image signals from an image sensor; modifying the plurality of original image signals based on a lens pattern, to generate a plurality of first image signals; obtaining compensation information of the plurality of first image signals; determining whether the plurality of first image signals match with a predetermined image pattern; modifying the plurality of first image signals according to the compensation information to generate a plurality of second image signals when the plurality of first image signals are determined to not match with the predetermined image pattern; and determining whether the plurality of second image signals match with the predetermined image pattern.

### BACKGROUND OF THE INVENTION

### 1. Field of the Invention

The present invention relates to an image processing method and system, and more particularly, to an image processing method and system for handling fingerprint images.

### 2. Description of the Prior Art

Fingerprint sensing technology is widely applied in a variety of electronic products such as a mobile phone, laptop, tablet, personal digital assistant (PDA), and portable electronics, for realizing identity recognition. The fingerprint sensing allows a user to perform identity recognition conveniently, where the user only needs to put his/her finger on a fingerprint sensor to login the electronic device instead of entering long and tedious username and password.

In recent years, the optical fingerprint recognition has become one of the most popular fingerprint recognition schemes. In an optical fingerprint sensing system, a fingerprint image sensor may be disposed together with a light source under the sensing pad or panel. During the sensing period, the light source delivers light and the sensor receives the light reflected from the touch fingerprint, to determine the peaks and valleys of fingerprint according to the received light intensity.

However, there are various noises and offsets included in the sensed image signals. These noises and offsets may limit a maximum possible amplification ratio performed on the effective fingerprint signals, increasing the burden and difficulty of fingerprint recognition. Thus, there is a need for improvement over the prior art.

### SUMMARY OF THE INVENTION

It is therefore an objective of the present invention to provide an image processing method and system, which are capable of effectively removing the unwanted offsets and enhancing the performance of fingerprint recognition.

An embodiment of the present invention discloses an image processing method, which comprises the steps of: receiving a plurality of original image signals from an image sensor; modifying the plurality of original image signals based on a lens pattern, to generate a plurality of first image signals; obtaining compensation information of the plurality of first image signals; determining whether the plurality of first image signals match with a predetermined image pattern; modifying the plurality of first image signals according to the compensation information to generate a plurality of second image signals when the plurality of first image signals are determined to not match with the predetermined image pattern; and determining whether the plurality of second image signals match with the predetermined image pattern.

Another embodiment of the present invention discloses an image processing system, which comprises an image processor and a host. The image processor is configured to perform the following steps: receiving a plurality of original image signals from an image sensor; modifying the plurality of original image signals based on a lens pattern, to generate a plurality of first image signals; and obtaining compensation information of the plurality of first image signals. The host, coupled to the image processor, is configured to perform the following step: determining whether the plurality of first image signals match with a predetermined image pattern. Wherein, the image processor is further configured to modify the plurality of first image signals according to the compensation information to generate a plurality of second image signals when the plurality of first image signals are determined to not match with the predetermined image pattern, and the host is further configured to determine whether the plurality of second image signals match with the predetermined image pattern.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image processing system according to an embodiment of the present invention.

FIG. 2 is a flowchart of an image processing process according to an embodiment of the present invention.

FIG. 3 is a schematic diagram of relative illumination of the lens.

FIG. 4 is a schematic diagram of light intensity compensation.

FIGS. 5A-5C are schematic diagrams of compensation of image signals for the fixed pattern offset according to an embodiment of the present invention.

FIGS. 6A-6C are schematic diagrams of amplifying the image signals according to an embodiment of the present invention.

### DETAILED DESCRIPTION

Please refer to FIG. 1, which is a schematic diagram of an image processing system 10 according to an embodiment of the present invention. As shown in FIG. 1, the image processing system 10 includes an image sensor 100, an image processor 102 and a host 104. In an embodiment, the image processing system 10 is configured to process fingerprint image signals to perform fingerprint recognition; hence, the image sensor 100 may be a fingerprint sensor. In general, the image sensor 100 may include a plurality of sensing pixels arranged as an array. If the image sensor 100 is an optical fingerprint sensor, a light source may further be included and disposed below the sensing pad. The light intensity reflected from the touch finger may be sensed in each sensing pixel to generate the fingerprint image signals, which are forwarded to the image processor 102 and the host 104 for recognizing the fingerprint image. The detailed structure of the pixel array of the image sensor 100 is well known by those skilled in the art, and thus omitted herein.

The image processor 102 may be an image processing circuit such as a fingerprint image processing integrated circuit (IC) implemented in a chip. In general, the image processor 102 is configured to receive image signals (which are usually voltage or current signals) from the image sensor 100 and convert the image signals into digital form, which is further sent to the host 104 for subsequent operation and determination. Therefore, an analog to digital converter (ADC) 106 may usually be implemented in the image processor 102 to perform the conversion. The image processor 102 may process the image signals to remove unwanted noises and offsets and improve the signal quality, allowing the output image signals or data to be recognized more effectively.

The host 104 may be a main processor of the electronic system, such as a central processing unit (CPU), a microcontroller unit (MCU), or the like. As for fingerprint recognition, the host 104 is served to perform matching and thereby determine whether the fingerprint sensing image received from the image sensor 100 is identical to a registered fingerprint image, in order to authenticate specific functions. Since the operation of fingerprint recognition requires more complex computation and more storage space for storing the registered fingerprint image, the fingerprint recognition is preferably performed in the host 104, in order to simplify the circuit area and cost of the image processor 102.

Please refer to FIG. 2, which is a flowchart of an image processing process 20 according to an embodiment of the present invention. The image processing process 20 may be implemented in an image processing system such as the image processing system 10 shown in FIG. 1, for processing the image signals such as fingerprint image signals. As shown in FIG. 2, the image processing process 20 includes the following steps:

Step 200: Start.

Step 202: The image processor 102 receives original image signals from the image sensor 100.

Step 204: The image processor 102 modifies the original image signals based on a lens pattern, to generate first image signals.

Step 206: The image processor 102 obtains compensation information of the image signals.

Step 208: The host 104 scans the image signals to determine whether the image signals match with a predetermined image pattern. If yes, go to Step 212; otherwise, go to Step 210.

Step 210: The image processor 102 modifies the first image signals according to the compensation information, to generate second image signals. Then go to Step 206.

Step 212: End.

According to the image processing process 20, when a finger is put on the sensing pad of the image sensor 100, original image signals may be sensed and received from the sensing pixels of the image sensor 100 (Step 202). Before or after the image processor 102 receives the original image signals from the image sensor 100, the original image signals may be appropriately modified to compensate a fixed pattern offset. The fixed pattern offset is a known offset generated from the lens pattern. Therefore, the original image signals may be compensated to generate modified image signals, e.g., the first image signals (Step 204). According to the levels of the first image signals, the compensation information for subsequent compensation steps may be obtained (Step 206). The host 104 may scan the first image signals to determine whether the first image signals match with a predetermined image pattern (Step 208). If the scan result is match, the image processing process 20 for fingerprint recognition ends and a target function may be enabled or unlocked. If the scan result is not match, the image processor 102 further modifies the first image signals according to the previously obtained compensation information, to generate the second image signals (Step 210). The compensation information provides compensation of offset and gain, where the fingerprint signals are amplified to increase the probability of successful matching. The host 104 then scans the second image signals and compares the second image signals with the predetermined image pattern to determine whether they are matched. If not, the image processor 102 may obtain related information and modify the second image signals again, and the host 104 may perform the matching step again. Although it is not illustrated in FIG. 2, the image processing process 20 may end with a failure matching if the scanning operation iterates by more than a specific number of times and the scan result still cannot match.

Before the scan operation starts, the image signals are preferably modified to compensate the fixed pattern offset. In an embodiment, the fixed pattern offset may be generated from the lens pattern. The lens pattern may refer to relative illumination of the lens corresponding to the distance of a sensing pixel from the center of the lens. Please refer to FIG. 3, which is a schematic diagram of relative illumination of the lens. As shown in FIG. 3, based on the optical feature of the lens, the central region (with shorter distance from the lens center) has higher relative illumination and the peripheral region (with longer distance from the lens center) has lower relative illumination. Therefore, there is a fixed pattern offset where the pixels at the central region usually have higher brightness and the pixels at the peripheral region usually have lower brightness, as the circles of equivalent brightness shown in FIG. 3. The difference of relative illumination may generate different magnitudes on the output image sensing signals, such that the image sensing signals may be carried on different voltage (or current) levels, causing the burden on subsequent determination and recognition.

In an embodiment, the fixed pattern offset may be compensated by controlling the emitted light intensity for each sensing pixel. If an image signal is generated from a sensing pixel in the central region of the lens, the level of the image signal may be modified or adjusted with lower light intensity during the sensing operation; and if an image signal is generated from a sensing pixel in the peripheral region of the lens, the level of the image signal may be modified or adjusted with higher light intensity during the sensing operation. The light intensity compensation may be applied to each sensing pixel in a pattern as shown in FIG. 4, which is inverse to the lens pattern of relative illumination as shown in FIG. 3. More specifically, the light intensity of the light source for the image sensor 100 may be increased gradually from the central region to the peripheral region of the lens, in order to compensate the optical feature of the lens that the relative illumination is higher at the central region. In this embodiment, the light intensity of the light source may be controlled and adjusted with a control signal from the image processor 102 or the host 104, or by any feasible method.

As mentioned above, the image processor 102 usually includes the ADC 106 for converting the image sensing signals into digital form, and the ADC 106 may process image signals within a specific range of level. For example, if the ADC 106 is configured to process voltage signals, it may be able to process voltage signals within a voltage range such as between 0 and 5V. If a received voltage signal is beyond the range, the voltage signal may not be correctly converted into a proper digital code, which may cause distortion of image signals after the analog to digital conversion. In addition, in order to increase the probability of successful fingerprint recognition, the image signals may be amplified in the analog front-end (AFE) circuit. However, the fixed pattern offset causes that the image signals received from pixels in different regions are carried on different levels, e.g., voltage levels. Note that the operating voltage range of the ADC 106 may correspond to a full scale (FS) of digital code. In original image signals without compensation, the relative illumination is higher at sensing pixels in the central region and is lower at sensing pixels in the peripheral region, resulting in higher voltage level of image signals from sensing pixels closer to the lens center and lower voltage level of image signals from sensing pixels further from the lens center, as shown in FIG. 5A.

After the offset of voltage levels is compensated, the image signal swings may be carried on the same voltage level, as shown in FIG. 5B. The signal compensation allows more sufficient room for further amplification of the image signals under the limited operating voltage range of the ADC 106, to realize better performance of fingerprint recognition.

The fixed pattern offset caused by lens pattern may also be compensated in other manners. In an embodiment, the fixed pattern offset may be compensated in the AFE circuit of the image processor 102. For example, compensation information related to the lens pattern may be stored in a gain table, and a gain may be added into the original image signals to modify the level of the original image signals, allowing the image signals to reach an identical voltage level. For example, as shown in FIG. 5C, the gain provided in the AFE circuit may push the image signals to a higher voltage level. The gain table may store a fixed pattern compensation data similar to the light source compensation pattern provided in FIG. 4. That is, a higher gain is applied to image signals from pixels in the peripheral region of the lens, and a lower gain or no gain is applied to image signals from pixels in the central region of the lens. After compensation of the fixed pattern offset, an image signal received from a pixel further from the lens center is pushed to a higher voltage level identical to an image signal received from a pixel closer to the lens center, as shown in FIG. 5C.

Please note that the information of fingerprint peaks and valleys is reflected as the signal swing, while different signal levels of different pixels are unwanted offset that should be removed. As shown in FIGS. 5A-5C, the sine-wave signals, which represent the magnitude of peak-to-valley difference of the received fingerprint, are the fingerprint signals to be applied to perform recognition. The level of each image signal may be regarded as a voltage or current value received by the ADC 106 or the data code outputted from the ADC 106, which should be under the full scale of the ADC 106. The above compensation manners allow the image signals to be carried on the same voltage or current level, and thus the unwanted offset may be removed.

Please refer back to FIG. 2. After the compensation of fixed pattern offset is completed to generate the first image signals, the image processor 102 may obtain the compensation information of the first image signals. Note that the compensation information herein is different from the above information for compensating the fixed pattern offset. In detail, the compensation information provided herein may include offset information and gain information, which are used to optimize the image signals by enhancing the signal amplitude to effectively utilize the operating voltage range of the ADC 106.

In addition, after the first image signals are converted into digital form and then sent to the host 104, the host 104 may perform a normal scan to determine whether the first image signals match with a predetermined image pattern. The predetermined image pattern may be a fingerprint image previously registered and stored in the storage device of the host 104. Match or not may be determined based on comparison of the fingerprint features such as loops, whorls and/or arches. The detailed implementations of fingerprint matching are well known by those skilled in the art, and thus omitted herein. If the scan result is match, the process of fingerprint recognition ends and a target function may be enabled or unlocked. If the scan result is not match, the image processor 102 may modify the first image signals according to the previously acquired compensation information, to generate the second image signals, which is further sent to the host 104 for performing matching.

Please refer to FIGS. 6A-6C, which are schematic diagrams of amplifying the image signals according to an embodiment of the present invention. FIG. 6A illustrates image signals SA1-SA3 which are obtained after compensation of fixed pattern offset and have an identical voltage or current level. In this embodiment, the offset information may include a minimum offset of the image signals SA1-SA3, which is obtained from the minimum one of the offset value of each of the image signals SA1-SA3. As shown in FIG. 6A, among the image signals SA1-SA3, the image signal SA1 has the minimum offset (as indicated by the arrows below the image signals SA1-SA3). Therefore, the minimum offset value may be subtracted from each of the image signals SA1-SA3, to obtain the image signals SB1-SB3 as shown in FIG. 6B.

As shown in FIG. 6B, since the minimum offset has been removed, the image signals SB1-SB3 may have larger headroom for amplification. The headroom may be regarded as the gain information acquired by the image processor 102, for determining a possible gain magnitude to be applied to the image signals SB1-SB3. The gain may be realized in the AFE circuit to increase the voltage swing of the image signals SB1-SB3 that represents the peak-to-valley difference of the fingerprint image, so as to improve the signal quality. Preferably, the image signals SB1-SB3 may be amplified to allow the maximum amplitude of the image signals to conform to the full scale of the data code. In other words, the maximum voltage value among the image signals SC1-SC3 may reach the maximum operating voltage of the ADC 106, as shown in FIG. 6C.

Therefore, after the fixed pattern offset is removed from the original image signals received from the image sensor 100 and after the offset information and the gain information are incorporated into the first image signals to generate the second image signals, the obtained second image signals (i.e., the image signals SC1-SC3) may fully utilize the entire operating voltage range of the ADC 106, so as to optimize the fingerprint image signals. At this moment, the host 104 may perform a retry scan to determine whether the second image signals match with the predetermined image pattern. Since the signal quality has been improved with the amplification of signal swing, the probability of successful matching may be increased in the retry scan. As a result, the image signal processing method provided in the present invention may enhance the fingerprint signal to increase the performance of fingerprint recognition.

Please note that the present invention aims at providing an image processing method and system for processing fingerprint image signals. Those skilled in the art may make modifications and alternations accordingly. For example, in the image processing process 20, after the first image signals are generated, the image processor 102 may obtain the compensation information of the first image signals (Step 206) and then the host 104 may perform the scan (Step 208). In another embodiment, Steps 206 and 208 may be performed concurrently. Alternatively, the scan operation may be performed first, and then the compensation information may be obtained only if the scan operation indicates that the fingerprint image fails to match and thus the offset information and gain information are required to further improve the signal quality. In another embodiment, if the image processor 102 has enough computation resources, the scan operation may be implemented in the image processor 102 instead of the host 104. Further, in the above embodiment, the ADC 106 receives voltage signals to generate digital codes. In another embodiment, the ADC 106 may be a current ADC and the image signals received by the ADC 106 may be in current form.

To sum up, the embodiments of the present invention provide an image processing method and system which are capable of effectively removing the unwanted offsets of the image signals and enhancing the performance of fingerprint recognition. In an embodiment, the fixed pattern offset generated from the lens pattern may be removed from the original image signals to let the image signal swings to be carried on the same voltage or current level, and then the host may perform a normal scan to determine whether the image signals match with a predetermined image pattern. If not, the image signals are further modified to remove the minimum offset and then be amplified to achieve higher signal amplitude, in order to fully utilize the operating voltage range of the ADC. With the amplified image signals, the host may perform a retry scan to perform matching. With the implementations of the present invention, the fingerprint image signals are optimized under the full scale of the ADC; hence, the performance of fingerprint recognition may be effectively improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method, comprising:
receiving a plurality of original image signals from an image sensor;
modifying the plurality of original image signals based on a lens pattern, to generate a plurality of first image signals;
obtaining compensation information of the plurality of first image signals;
determining whether the plurality of first image signals match with a predetermined image pattern;
modifying the plurality of first image signals according to the compensation information to generate a plurality of second image signals when the plurality of first image signals are determined to not match with the predetermined image pattern; and
determining whether the plurality of second image signals match with the predetermined image pattern.

2. The image processing method of claim 1, wherein the compensation information comprises at least one of offset information and gain information.

3. The image processing method of claim 1, wherein the step of modifying the plurality of first image signals according to the compensation information to generate the plurality of second image signals comprises:
removing a minimum offset of the plurality of first image signals from each of the plurality of first image signals; and
amplifying the plurality of first image signals to allow a maximum amplitude of the plurality of first image signals to conform to a full scale of a processing circuit for the plurality of first image signals.

4. The image processing method of claim 3, wherein the full scale is an operating voltage range of an analog to digital converter.

5. The image processing method of claim 1, wherein the step of modifying the plurality of original image signals based on the lens pattern to generate the plurality of first image signals comprises:
modifying a level of the plurality of original image signals by controlling light intensity corresponding to each of the plurality of original image signals, to generate the plurality of first image signals.

6. The image processing method of claim 1, wherein the step of modifying the plurality of original image signals based on the lens pattern to generate the plurality of first image signals comprises:
modifying a level of the plurality of original image signals in an analog circuit by referring to a gain table corresponding to a pixel position of the plurality of original image signals, to generate the plurality of first image signals.

7. The image processing method of claim 1, wherein each of the plurality of first image signals is generated by compensating relative illumination corresponding to a distance of a corresponding sensing pixel from the center of a lens.

8. An image processing system, comprising:
an image processor, configured to perform the following steps:
receiving a plurality of original image signals from an image sensor;
modifying the plurality of original image signals based on a lens pattern, to generate a plurality of first image signals; and
obtaining compensation information of the plurality of first image signals;
a host, coupled to the image processor, configured to perform the following step:
determining whether the plurality of first image signals match with a predetermined image pattern;
wherein the image processor is further configured to modify the plurality of first image signals according to the compensation information to generate a plurality of second image signals when the plurality of first image signals are determined to not match with the predetermined image pattern; and
wherein the host is further configured to determine whether the plurality of second image signals match with the predetermined image pattern.

9. The image processing system of claim 8, wherein the compensation information comprises at least one of offset information and gain information.

10. The image processing system of claim 8, wherein the image processor is configured to perform the following steps to modify the plurality of first image signals according to the compensation information to generate the plurality of second image signals:
removing a minimum offset of the plurality of first image signals from each of the plurality of first image signals; and
amplifying the plurality of first image signals to allow a maximum amplitude of the plurality of first image signals to conform to a full scale of a processing circuit of the image processor.

11. The image processing system of claim 10, wherein the full scale is an operating voltage range of an analog to digital converter.

12. The image processing system of claim 8, wherein the image processor is configured to perform the following step to modify the plurality of original image signals based on the lens pattern to generate the plurality of first image signals:
modifying a level of the plurality of original image signals by controlling light intensity corresponding to each of the plurality of original image signals, to generate the plurality of first image signals.

13. The image processing system of claim 8, wherein the image processor is configured to perform the following step to modify the plurality of original image signals based on the lens pattern to generate the plurality of first image signals:
modifying a level of the plurality of original image signals in an analog circuit by referring to a gain table corresponding to a pixel position of the plurality of original image signals, to generate the plurality of first image signals.

14. The image processing system of claim 8, wherein each of the plurality of first image signals is generated by compensating relative illumination corresponding to a distance of a corresponding sensing pixel from the center of a lens.
